(19) United States
(12) Patent Application Publication
(10) Pub. No.: US 2007/0255691 A1
(43) Pub. Date: Nov. 1, 2007

(54) METHODS AND APPARATUS FOR CREATING AN INSTRUCTIONAL PROGRAM

(75) Inventor: Thomas Uhrland Snyder, Bethesda, MD (US)

Correspondence Address: BELL, BOYD & LLOYD, LLP, P.O. Box 1135, CHICAGO, IL, 60690, US

(73) Assignee: Huthwaite, Inc., Chicago, IL (US)

(21) Appl. No.: 11/619,036

(22) Filed: Jan. 2, 2007

Related U.S. Application Data
(60) Provisional application No. 60/745,700, filed on Apr. 26, 2006.

(51) Int. Cl. G06F 17/30

(52) U.S. Cl. 707/3

(57) ABSTRACT

Methods and apparatus for creating a sales person (or other client-facing personnel) instructional program are disclosed. The methods target a sales (or other client-facing) group with customized instructional content tailored to that group's needs. A pre-assessment test evaluates each individual on each of several different sales-related behaviors. A job task analysis and/or a customer segmentation analysis determines the context of the customer interaction situation. Based on the combined results of the pre-assessment tests, the job task analysis, and/or the customer segmentation analysis, a subset of behaviors is selected that are needed for this sales (or sales-related) group to do its job effectively and are also behaviors in which the group has a deficiency. Based on the selected subset of sales-related behaviors, a subset of predetermined instructional content is retrieved that targets those behaviors. Preferably, the predetermined instructional content is mapped to the behaviors and to different steps in an instructional process by a matrix or some other data structure. Any dynamic content is customized to further target the particular sales or sales-related group.

### PRIORITY CLAIM

This application is a continuation of, claims priority to and the benefit of U.S. Patent Application Ser. No. 60/745,700, filed Apr. 26, 2006, the entire contents of which are incorporated herein.

### TECHNICAL FIELD

The present disclosure relates in general to providing an instructional program, and, in particular, to methods and apparatus for creating and providing an instructional program to teach sales skills.

### BACKGROUND

Not all sales people are equally effective at their jobs. Certain sales people exhibit certain behaviors that help them do their job. Other sales people do not exhibit certain behaviors which would help them do their job. For example, some sales people are better than others at getting to the right decision maker of a potential customer, getting that decision maker to articulate the potential customer's problem, and properly addressing that problem to facilitate a sale.

There are numerous known books sales people can read and known courses they can take to attempt to improve their sales skills. However, the content of these existing educational materials can be ineffective or less than maximally effective for many different reasons. First, the content is typically based on opinion and tradition. For example, certain sale closing techniques are considered essential by many existing sales educational materials. However, such sale closing techniques often do not work in certain circumstances, with certain people or in certain industries.

Second, the content of existing sales educational materials typically cover a broad spectrum of fixed topics. Often, books and courses will actually promote the fact that their material covers everything. However, not all sales people's skills are deficient in all areas and many sales people are proficient in certain areas and deficient in others. The areas of proficiency and deficiency varies from person to person and from company to company. Accordingly, a full spectrum approach is inefficient for the vast majority of sales people and companies, and may actually reduce the overall improvement by focusing the sales person on material the sales person does not need. In addition, existing content is typically in the form of fixed text books or canned software programs that are not geared or tailored toward specific measured needs and do not change to accommodate those needs.

Third, the content of existing sales educational materials is typically generic in an attempt to appeal to a diverse target audience. For example, one sales person buying the book or taking the course may be selling coffee beans, while another sales person buying the book or taking the course may be selling main frame computers. However, the type of instruction that is most effective for different types of sellers is typically different. The behaviors needed to sell coffee beans are different than the behaviors needed to sell main frame computers. In addition, instructional content (even for the same topic) is more effectively learned and retained if taught in one way to a coffee bean sales person and taught in another way to a main frame computer sales person.

Fourth, many sales people do not recognize, or fully understand their own deficiencies. Thus, even if a sales person tries to only select materials from a book or software package that they think they need, they may be missing certain areas or concentrating on incorrect areas. Other problems may exist with each of the known products that sales people use to improve their performance.

### SUMMARY

The methods disclosed herein solve these problems by targeting individual sales people or sales groups with customized instructional content created or tailored to that person or group's needs. Specifically, the methods disclosed herein start with a plurality of sales behaviors that the implementer of the present system and method can determine to be a complete set of sales behaviors (e.g., behaviors such as seeking and clarifying). This set of behaviors can be any suitable set of behaviors. The sales behaviors can be determined in any suitable manner such as recorded observations from actual sales calls using appropriate methods. The sales behaviors can vary from one system and method implementation to the next system and method implementation, even though a complete set of possible potential behaviors may be employed in each system implementation.

This list of sales behaviors is reduced to a particular subset of sales behaviors that targets a particular sales person or group. In one embodiment, to accomplish this, a pre-assessment test is given to each person in the group. The pre-assessment test is designed to evaluate each sales person on each of the different sales behaviors. In addition, a job task analysis (e.g., where in the purchasing process does this sales group typically sell) and a customer segmentation analysis (e.g., what size customer does this sales group typically sell to and/or what is the complexity level of the product or services being sold) are performed in various embodiments. Based on the combined results of the pre-assessment tests, the job task analysis, and/or the customer segmentation analysis, the list of sales behaviors is reduced to a subset of sales behaviors that are needed for this sales group to do their job effectively and are also behaviors that this sales group has a deficiency with. Thus, in one embodiment, the results are on a group basis, such as all of the sales people in a company that sell radio advertising. While every person in this group may not de deficient in each identified area, suitable norms are created to help the group as a whole. In another embodiment, individuals are treated separately.

Based on the selected subset of sales behaviors, a subset of predetermined instructional content is retrieved (from a larger or total group of instructional content) that targets those behaviors to create or provide the instructional program. In one embodiment, the predetermined instructional content is mapped to the behaviors and to different steps in an instructional process using a multi-dimensional matrix or another suitable data structure. In certain embodiments, this mapping is suitably computer implemented. Certain of that content is static (e.g., a chapter in a book that does not change), and certain of that content is dynamic (e.g., a role playing template). The dynamic content is customized to further target the particular sales group. For example, a role playing exercise designed to teach a seeking behavior to coffee bean salesmen is placed in a coffee bean sales context, while the same role playing exercise is placed in a computer sales context for computer sales people.

These determined and obtained set of group specific instruction content is provided to the sales people in one or more suitable formats.

Additional features and advantages are described herein, and will be apparent from, the following Detailed Description and the figures.

### BRIEF DESCRIPTION OF THE FIGURES

FIG. 1 is a block diagram of an instructional program creation system.

FIG. 2 is a block diagram of a series of steps for purchasing products.

FIG. 3 is a high level block diagram of a communications system.

FIG. 4 is a more detailed block diagram showing one example of a computing device and/or a web server.

FIG. 5 is a flowchart of an example process to create an instructional program to teach sales people sales skills.

FIG. 6 is a matrix mapping behaviors and steps in an instructional process to instructional content.

### DETAILED DESCRIPTION OF EXEMPLARY EMBODIMENTS

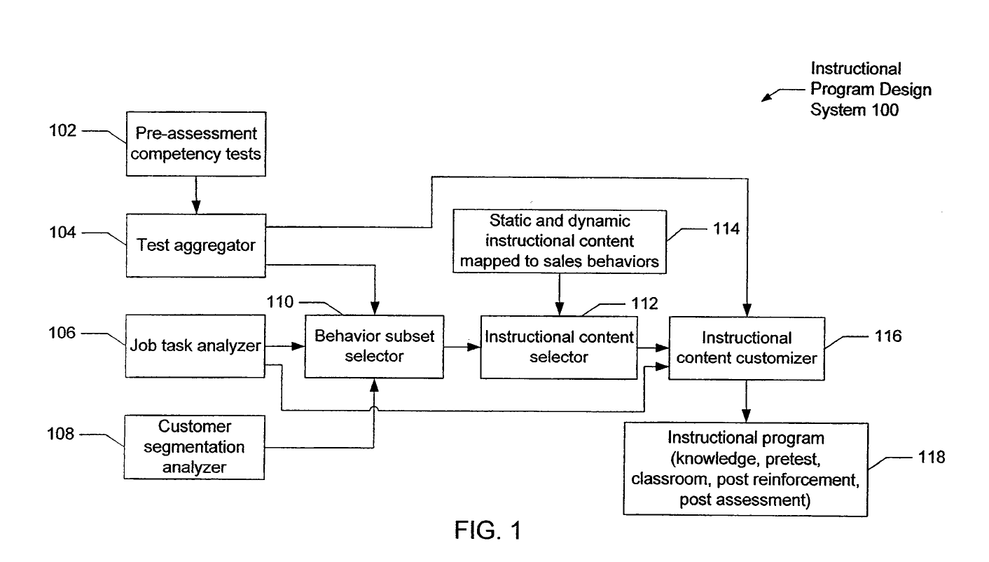

An example instructional program creation system 100 is illustrated in FIG. 1. The function of each of the blocks in the system 100 may be performed by a person and/or by a computing device. In this example, one or more pre-assessment competency tests 102 are given to one or more people. In one embodiment, a group of sales people in a company undergo these tests. Competency areas are areas of personal capability that enable people to perform successfully in their jobs by completing tasks effectively. For example, competency can be based on knowledge, attitude, skill, and/or values. Competency in a particular area can be acquired through talent, experience, and/or training. A person is typically considered competent in a particular area if that person can apply his/her knowledge and skill at or above a standard of performance that is required for that person's particular job.

The pre-assessment competency test(s) are preferably designed to evaluate the test taker's sales behaviors in several different competency areas. For example, questions on the pre-assessment competency test may be divided into a call execution skills area, a strategic opportunity development area, a pipeline management area, a deal negotiation area, a presentations area, a proposals area, a prospecting area, an interactive skills area, and/or a coaching area.

The pre-assessment competency test(s) may be subjective and/or objective. A subjective pre-assessment competency test may ask a test taker to self-evaluate. For example, a subjective pre-assessment competency test may ask the test taker if he/she “Sets call objectives that move opportunities forward.” Possible responses may include a spectrum of answers such as “To a very small extent,” “To a small extent,” “To a moderate extent,” “To a great extent,” “To a very great extent,” and “Don't know.” An objective pre-assessment competency test may ask a test taker a series of questions, wherein each question is followed by one best answer and several detractors. For example, an objective pre-assessment competency test may describe a certain sales scenario and ask the test taker a multiple choice question about how he/she would handle a situation within that scenario.

In one embodiment, the pre-assessment competency test 102 is given to a group of sales people in a company or other organization. In such an instance, a test aggregator 104 preferably combines the individual test scores into an aggregated set of test scores. For example, the test aggregator 104 may calculate the average response for each test question across all of the individuals taking the test. As used herein “sales person” or “sales people” refers to any client facing personnel such as customer service representatives, marketing personnel, managers, etc.

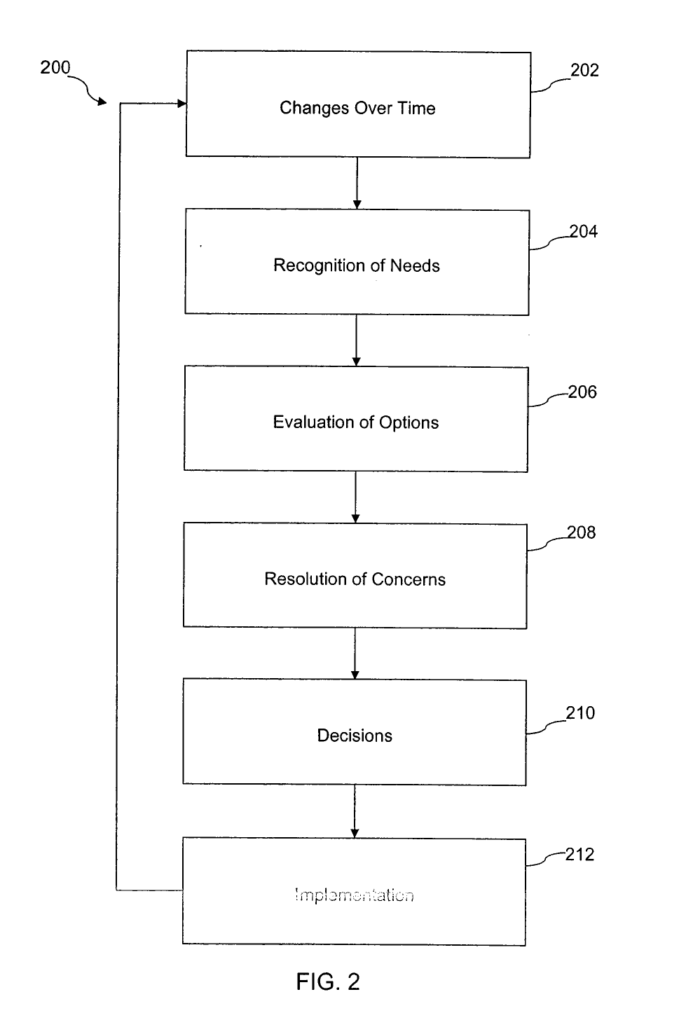

In addition to evaluating the existing skill set of the sales group, a job task analyzer 106 evaluates the types of sales skills that are needed by a particular sales group. For example, the job task analyzer 106 may determine one or more portions of a purchasing process 200 that are most relevant to a particular sales group. An example purchasing process 200 is illustrated in FIG. 2. In this example, the purchasing process 200 includes a “changes over time” phase 202, a “recognition of needs phase” 204, an “evaluation of options” phase 206, a “resolution of concerns” phase 208, a “decision” point 210, and an “implementation” phase 212.

During the changes over time phase 202, a buyer experiences a new business problem. For example, a car owner may experience wear and tear on his current vehicle. During the recognition of needs phase 204, the buyer realizes there is a problem that must be solved. For example, the car owner may have a car problem that prevents him from driving his car. During the evaluation of options phase 206, the buyer explores the available solutions. For example, the car owner may explore repairing his current car and/or buying a new car. During the resolution of concerns phase 208, the buyer seeks evidence that the favored solution is the best choice. For example, the car owner may confirm that the new car he has selected meets all of his safety criteria. At the decision point 210, the buyer authorizes the purchase. For example, the car owner may sign a contract to purchase the new vehicle. During the implementation phase 212 the buyer puts the new solution in place. For example, the car owner takes possession of and begins to use the new car. Subsequently, the purchasing process starts over during another changes over time phase 202 when the buyer experiences another new problem. For example, the new car will eventually experience problems of its own.

In addition to evaluating the existing skill set of the sales group and analyzing the job task of the sales group, a customer segmentation analyzer 108 evaluates the types of customers that are targeted by the particular sales group. For example, some sales groups target primarily large customers and other sales groups target small customers. Similarly, some sales groups market complex products such as telecommunications equipment. Other sales groups market commodity products such as sugar.

A behavior subset selector 110 uses any or all of these factors (pre-assessment competency test results, job task analysis results, and/or customer segmentation analysis results) to select a subset of behaviors from a predetermined set of behaviors. For example, the behavior subset selector 110 may select all of the behaviors that are determined to be both needed behaviors by the job task analyzer 106 and weak behaviors by the test aggregator 104. Similarly, the behavior subset selector 110 may select all of the behaviors that are determined to be both needed behaviors by the customer segmentation analyzer 108 and weak behaviors by the test aggregator 104.

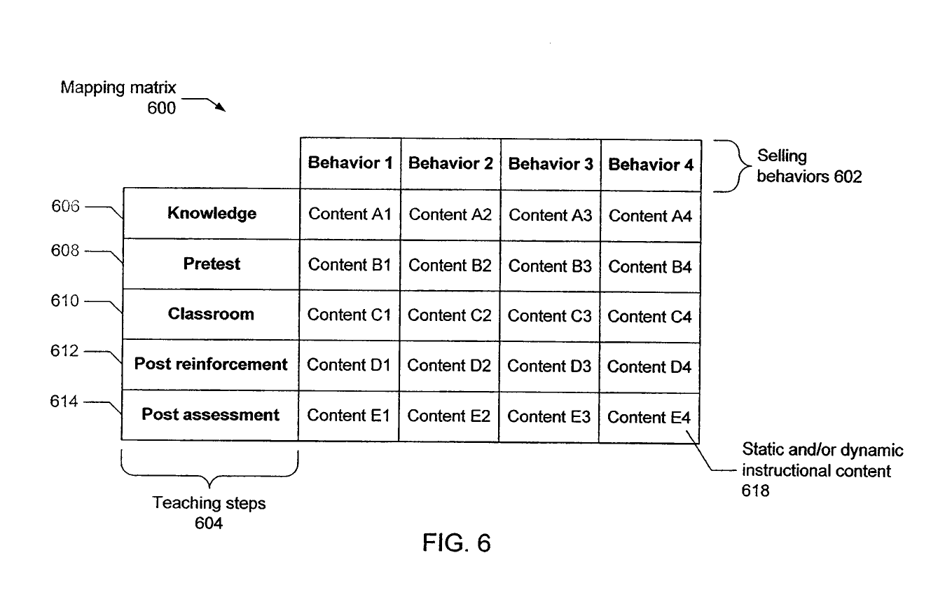

Once a subset of behaviors is selected, an instructional content selector 112 selects static and/or dynamic instructional content 114 based on a mapping of that instructional content 114 to the behaviors selected by the behavior subset selector 110. For example, instructional content 114 may be mapped to sales behaviors in a matrix format with one axis of the matrix representing a plurality of sales behaviors (e.g., seeking behavior, clarifying behavior, etc.) and the other axis of the matrix representing steps in a teaching process (e.g., a knowledge gaining step, a pretest step, a classroom step, a post reinforcement step, and/or a post assessment step). Such a matrix is described in more detail below with reference to FIG. 6.

Static instructional content is instructional content that typically does not change. For example, a chapter of a text book is designed to teach a certain skill and typically does not change. Dynamic instructional content is instructional content that is typically customized or changes. An instructional content customizer 116 converts the dynamic instructional content into application specific instructional content. For example, a role playing exercise may be templated to teach a certain sales skill and customized to be more on point and interesting to the occupation of the sales person. Preferably, customization of dynamic instructional content is based on the output of the job task analyzer 106 and/or the customer segmentation analyzer 108.

The static and/or dynamic instructional content is combined into an instructional program 118. Preferably, the instructional program includes a knowledge portion, a pretest portion, a classroom portion, a post reinforcement portion, and a post assessment portion. Each of these instructional program portions are described in more detail below with reference to FIG. 6.

Some or all of the final instruction program 118 may be delivered through a computerized system such as through a data network environment. One such network is the internet which enables a sales person to access the program via a web interface. For example, during the knowledge gaining step, the student may be required to complete a series of online lessons.

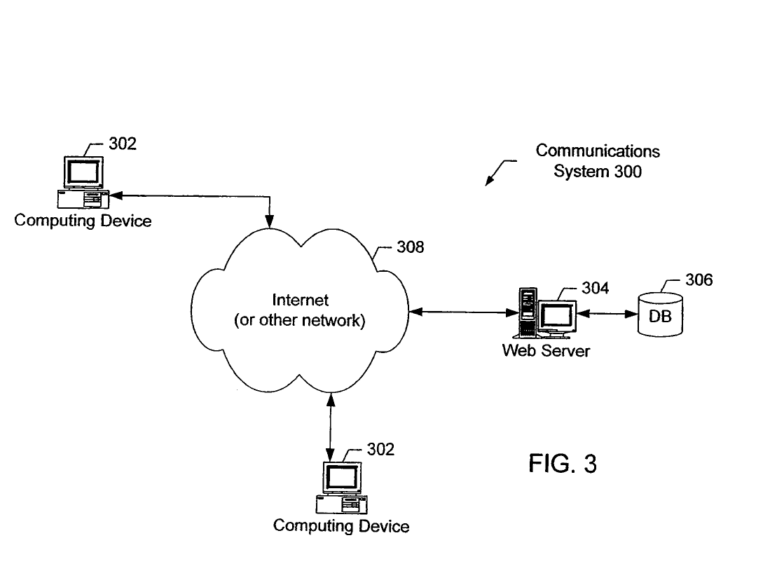

A high level block diagram of an exemplary network communications system 300 is illustrated in FIG. 3. However, it should be appreciated that any suitable system may be employed in accordance with the present disclosure. The illustrated system 300 includes one or more computing devices 302, one or more web servers 304, and one or more databases 306. Each of these devices may communicate with each other via a connection to one or more communications channels 308 such as the Internet or some other data network, including, but not limited to, any suitable wide area network or local area network. It will be appreciated that any of the devices described herein may be directly connected to each other instead of over a network.

The web server 304 stores a plurality of files, programs, and/or web pages in one or more databases 306 for use by the computing devices 302. The database 306 may be connected directly to the web server 304 and/or via one or more network connections. The database 306 stores instructional content. For example, the database may store text, graphics, and/or video for insertion in to a web page that describes certain sales behaviors and how they are best used.

One web server 304 may interact with a large number of computing devices 302. Accordingly, each web server 304 is typically a high end computer with a large storage capacity, one or more fast microprocessors, and one or more high speed network connections. Conversely, relative to a typical web server 304, each computing device 302 typically includes less storage capacity, a single microprocessor, and a single network connection.

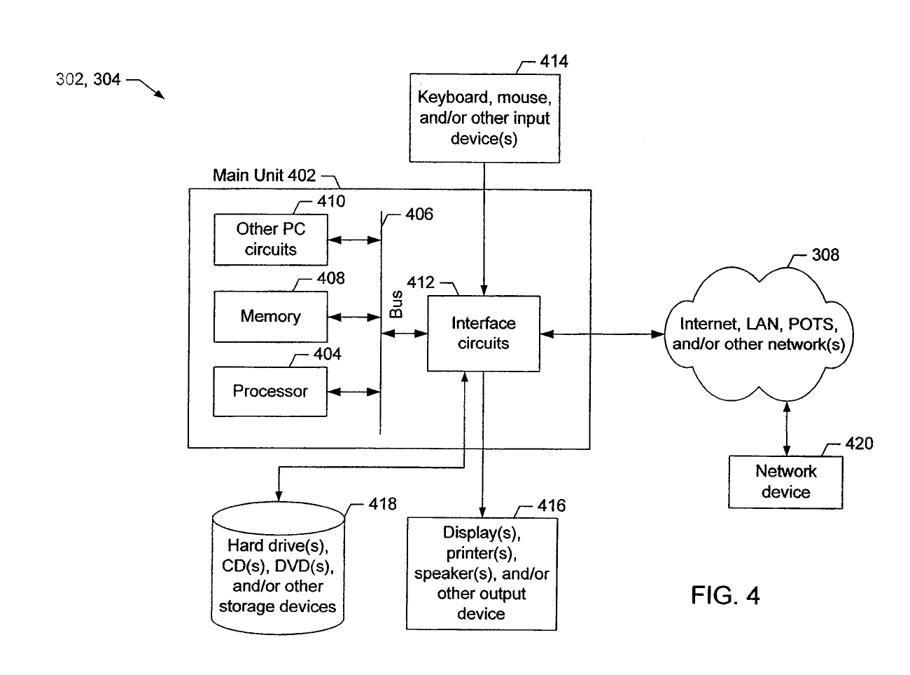

A more detailed block diagram of the electrical systems of a computing device 302 and/or a web server 304 is illustrated in FIG. 4. The computing device 302 and/or a web server 304 includes a main unit 402 which preferably includes one or more processors 404 electrically coupled by an address/data bus 406 to one or more memory devices 407, other computer circuitry 410, and one or more interface circuits 412. The processor 404 may be any suitable processor, such as a microprocessor from the INTEL PENTIUM® family of microprocessors. The memory 408 preferably includes volatile memory and non-volatile memory. Preferably, the memory 408 stores a software program that interacts with the other devices in the system 300 as described herein. This program may be executed by the processor 404 in any suitable manner. The memory 408 may also store digital data indicative of documents, files, programs, web pages, etc. retrieved from a server 404 and/or loaded via an input device 414.

The interface circuit 412 may be implemented using any suitable interface standard, such as an Ethernet interface and/or a Universal Serial Bus (USB) interface. One or more input devices 414 may be connected to the interface circuit 412 for entering data and commands into the main unit 402. For example, the input device 414 may be a keyboard, mouse, touch screen, track pad, track ball, isopoint, and/or a voice recognition system.

One or more displays, printers, speakers, and/or other output devices 416 may also be connected to the main unit 402 via the interface circuit 412. The display 416 may be a cathode ray tube (CRTs), liquid crystal displays (LCDs), or any other type of display. The display 416 generates visual displays of data generated during operation of the computing device 302 and/or the web server 304. For example, the display 416 may be used to display web pages received from the web server 304. The visual displays may include prompts for human input, run time statistics, calculated values, data, etc.

One or more storage devices 418 may also be connected to the main unit 402 via the interface circuit 412. For example, a hard drive, CD drive, DVD drive, and/or other storage devices may be connected to the main unit 402. The storage devices 418 may store any type of data used by the computing device 302 and/or the web server 304.

The computing device 302 and/or the web server 304 may also exchange data with other network devices 420 via a connection to the network 308. The network connection may be any type of network connection, such as an Ethernet connection, digital subscriber line (DSL), telephone line, coaxial cable, etc. Users of the system 300 may be required to register with the web server 304. In such an instance, each user may choose a user identifier (e.g., e-mail address) and a password which may be required for the activation of services. The user identifier and password may be passed across the network 308 using encryption built into a user's Internet browser. Alternatively, the user identifier and/or password may be assigned by the server 304.

Clients may connect to the web server 304 to access data and view or generate reports. Access to the web server 304, databases and reports can be controlled by appropriate security software or security measures. An individual member's access can be defined in the system and limited to certain data, information and reports. Access to non-authorized data, information and reports, such as another individual's investment information or aggregated investment information, can be prohibited.

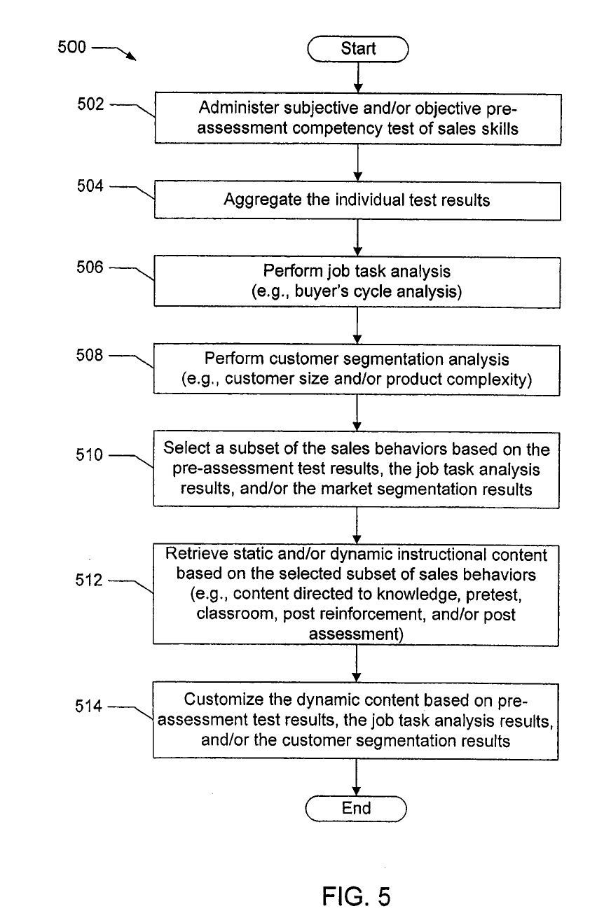

A flowchart of an example process 500 for creating an instructional program to teach sales people sales skills is illustrated in FIG. 5. Although the process 500 is described with reference to the flowchart illustrated in FIG. 5, it will be appreciated that many other methods of performing the acts associated with process 500 may be used. For example, the order of many of the steps may be changed, and many of the steps described are optional. In addition, any number of the steps may be performed by one or more people, and any number of the steps may be performed by a computing device 302 and/or a server 304.

Generally, the process 500 produces an instructional program for teaching sales skills. The process 500 targets a sales group with customized instructional content tailored to that group's needs. To accomplish this, a pre-assessment test is given to each person in the identified sales group. The pre-assessment test evaluates each individual on each of several different sales behaviors. In addition, a job task analysis and/or a customer segmentation analysis may be performed. Based on the combined results of the pre-assessment tests, the job task analysis, and/or the customer segmentation analysis, a subset of sales behaviors is selected that are needed for this sales group to do their job effectively and are also behaviors that this sales group has a deficiency in. Based on the selected subset of sales behaviors, a subset of predetermined instructional content is retrieved that targets those behaviors. Preferably, the predetermined instructional content is mapped to the behaviors and to different steps in an instructional process by a matrix or some other suitable data structure. Any dynamic content is customized to further target the particular sales group.

The example process 500 begins by administering a pre-assessment test to a plurality of people (block 502). For example, the pre-assessment test may be a competency test administered to the sales people at ABC Company. The purpose of the competency test is to identify each individual sales person's degree of sales-related knowledge, skills, and/or abilities. The pre-assessment test measures an individual's level of competency on a plurality of predetermined sales skills. As described above, the pre-assessment test may be subjective or objective. For example, the pre-assessment test may ask the test taker if he/she “plans questions to uncover and develop needs.” Although individual test results may be analyzed, typically the process 500 aggregates the test scores from a group of related people (block 504). For example, all of the sales people in a particular company or department may be grouped together into an aggregated score. The individual test results are aggregated to develop an understanding of the entire company's salesforce's knowledge, skills, and/or abilities. The individual results may be aggregated in ways specified by ABC Company. For example, the results may be aggregated by competency, by business unit, by sales manager, etc. As described above, the scores may be aggregated by computing a group average score for each question.

In addition, the example process 500 includes a job task analysis step (block 506). Job task analysis may include interviewing people associated with the tested sales group and/or observing people associated with the tested sales group to identify their daily job tasks within ABC Company. For example, the job task analysis may include a determination of what portion(s) of the purchasing process 300 the customers associated with the tested sales group are typically in. The job task analysis may include interviewing all of the people in the tested group or a subset of the people in the tested group. Preferably, these individuals would represent “high performers” and/or “low performers.” In addition, these individuals would preferably include those that are accustomed to selling to large clients and/or those that are accustomed to selling to small clients. Further, these individuals would preferably include those that are accustomed to complex client engagements and/or those that are accustomed to simple client engagements.

In addition, the example process 500 includes a customer segmentation analysis step (block 508). For example, ABC Company's typical customers and/or clients may be profiled and analyzed. Customer segmentation analysis may include interviewing people associated with the tested sales group and/or observing people associated with the tested sales group. For example, the customer segmentation analysis may include a determination of a typical customer size associated with the tested sales group and/or a product complexity associated with the tested sales group.

Based on the aggregated test scores (block 504), the results of the job task analysis (block 506), and/or the results of the customer segmentation analysis step (block 508), the process 500 selects a subset of predetermined sales behaviors (block 510). The selected subset of sales behaviors are preferably the ones that are the most strategically significant to affecting a positive business outcome for the company. For example, if the results of the job task analysis indicate that behaviors A, B, and C are behaviors that the tested sales group would benefit significantly from, and the aggregated test scores indicate that the tested sales group is deficient on behaviors A, C, and D, the behavior subset selector 110 may select behaviors A and C (i.e., the intersection of the job task analysis results and the pre-assessment test results). In order to determine if a particular sales group is deficient on a particular behavior, a threshold for each behavior may be set. For example, behavior A may have an aggregated threshold at one level, and behavior B may have an aggregated threshold at another level.

Each of these strategically significant sales behaviors is associated with instructional content designed to be delivered to the company's salesforce. Accordingly, based on the selected behaviors, the process 500 retrieves instructional content (block 512). In one embodiment, the behavior subset selector 110 uses a matrix to map behaviors and steps in an instructional process to the content. It will be appreciated that any suitable mapping structure may be used to associate behaviors and/or steps in an instructional process to instructional content.

An example mapping matrix 600 is illustrated in FIG. 6. In this example, the columns of the matrix are labeled with a plurality of different selling behaviors 602. Any suitable selling behaviors may be used. For example, seeking and clarifying behaviors such as asking a speaker for an example may be used as the behaviors in the columns.

This content preferably comes in a variety of forms including pre-work, pre-testing, classroom training, post reinforcement, and/or post-assessment materials. The rows of the example matrix 600 are labeled with these teaching steps 604. For example, a first step in a teaching process may be a knowledge step 606. During the knowledge step 606, the student attempts to prepare for later steps in the learning process by gaining some basic knowledge about a behavior. For example, the student may be asked to read some information about a particular sales behavior. The second row is associated with a pretest step 608. The purpose of the pretest step 608 is to determine if the student gained enough knowledge during the knowledge step 606 to move on to a classroom step 610. The classroom step 610 may include experiential learning such as role playing exercises. A post reinforcement step 612 may include a coaching portion, an individual activities portion, or a group activities portion. A post assessment step 614 may include a level one survey, a level two cognitive ability assessment, a level three behavioral assessment, and/or a level four correlation assessment.

The cells of the mapping matrix are associated with instructional content 618. For example, content associated with the knowledge step and the seeking behavior may include predetermined text, diagrams, and/or web pages designed to teach what a seeking behavior is and how seeking behavior are effectively used in sales.

Preferably, some of the instructional content is static and some of the instructional content is dynamic. As described above, static instructional content is instructional content that typically does not change, and dynamic instructional content is instructional content that is typically customized. The instructional content customizer 116 converts the dynamic instructional content into application specific instructional content (block 514). Preferably, the customization is based on the pre-assessment test results from block 502 and/or block 504, the job task analysis results from block 506, and/or the customer segmentation results from block 508. For example, depending upon ABC Company's preferences, the instructional content may be customized to reflect ABC Company's unique marketplace and client sales interactions. This may be accomplished through customized role plays, exercises, client tools, etc., which are preferably built through collaboration with ABC Company's subject matter experts.

In summary, persons of ordinary skill in the art will readily appreciate that methods and apparatus for providing a sales person instructional program been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

The invention is claimed as follows:

1. A method of providing an instructional program for a plurality of sales people, the method comprising:
administering a pre-assessment competency test of sales skills to the plurality of sales people to produce a plurality of individual test results;
aggregating the plurality of individual test results into a group test result;
performing a job task analysis associated with the plurality of sales people to produce a job task analysis result;
selecting a subset of sales behaviors from a plurality of predetermined sales behaviors based on the job task analysis result and the group test result; and
retrieving instructional content based on the selected subset of sales behaviors to provide at least a portion of the sales person instructional program.

2. The method of claim 1, wherein administering the pre-assessment competency test of sales skills includes administering a subjective pre-assessment competency test of sales skills.

3. The method of claim 1, wherein administering the pre-assessment competency test of sales skills includes administering an objective pre-assessment competency test of sales skills.

4. The method of claim 1, wherein administering the pre-assessment competency test of sales skills includes administering a hybrid subjective/objective pre-assessment competency test of sales skills.

5. The method of claim 1, wherein performing the job task analysis includes providing at least one question to analyze the mindset of a prototypical buyer.

6. The method of claim 1, further comprising performing customer segmentation analysis associated with the plurality of sales people to produce a customer segmentation analysis result.

7. The method of claim 6, wherein selecting the subset of sales behaviors from the plurality of predetermined sales behaviors is based on the customer segmentation analysis result.

8. The method of claim 7, wherein the customer segmentation analysis result includes a customer size indicator and a product complexity indicator.

9. The method of claim 1, wherein the retrieved instructional content is associated with (i) a knowledge portion of the instructional program, (ii) a pretest portion of the instructional program, (iii) a classroom portion of the instructional program, (iv) a post reinforcement portion of the instructional program, and (v) a post assessment portion of the instructional program.

10. The method of claim 9, wherein the post reinforcement portion of the instructional program includes at least one of a coaching portion, an individual activities portion, and a group activities portion.

11. The method of claim 9, wherein the post assessment portion of the instructional program includes a level two cognitive ability assessment.

12. The method of claim 9, wherein the post assessment portion of the instructional program includes a level three behavioral assessment.

13. The method of claim 9, wherein the post assessment portion of the instructional program includes a level four correlation assessment.

14. The method of claim 1, wherein a first portion of the retrieved instructional content is static content and a second portion of the content is dynamic content.

15. The method of claim 14, further comprising customizing the dynamic content based on the job task analysis result.

16. The method of claim 1, wherein a first portion of the retrieved content is static content and a second portion of the content is dynamic content, the method including:
performing customer segmentation analysis associated with the plurality of sales people to produce a customer segmentation analysis result; and
customizing the dynamic content based on the customer segmentation analysis result.

17. A method of providing an instructional program for a plurality of sales people, the method comprising:
administering a pre-assessment competency test of sales skills to the plurality of sales people to produce a plurality of individual test results;
aggregating the plurality of individual test results into a group test result;
selecting a subset of sales behaviors from a plurality of predetermined sales behaviors based on the group test result; and
retrieving instructional content based on the selected subset of sales behaviors to provide at least a portion of the sales person instructional program, the instructional content including instructional content associated with (i) a knowledge portion of the instructional program, (ii) a pretest portion of the instructional program, (iii) a classroom portion of the instructional program, (iv) a post reinforcement portion of the instructional program, and (v) a post assessment portion of the instructional program.

18. The method of claim 17, wherein administering the pre-assessment competency test of sales skills includes administering an objective pre-assessment competency test of sales skills.

19. The method of claim 17, including providing at least one question to analyze the mindset of a prototypical buyer associated with the plurality of sales people to produce a purchasing process analysis result, wherein selecting the subset of sales behaviors from the plurality of predetermined sales behaviors is based on the purchasing process analysis result.

20. The method of claim 17, further comprising performing customer segmentation analysis associated with the plurality of sales people to produce a customer segmentation analysis result, wherein selecting the subset of sales behaviors from the plurality of predetermined sales behaviors is based on the customer segmentation analysis result.

21. The method of claim 20, wherein the customer segmentation analysis result includes a customer size indicator and a product complexity indicator.

22. The method of claim 17, wherein the post reinforcement portion of the instructional program includes at least one of a coaching portion, an individual activities portion, and a group activities portion.

23. The method of claim 17, wherein the post assessment portion of the instructional program includes at least one of a level two cognitive ability assessment, a level three behavioral assessment, and a level four correlation assessment.

24. The method of claim 17, including performing a job task analysis associated with the plurality of sales people to produce a job task analysis result, wherein a first portion of the retrieved instructional content is static content and a second portion of the content is dynamic content, the method including customizing the dynamic content based on the job task analysis result.

25. A method of providing an instructional program for a plurality of sales people, the method comprising:
performing a job task analysis associated with the plurality of sales people to produce a job task analysis result;
selecting a subset of sales behaviors from a plurality of predetermined sales behaviors based on the job task analysis result; and
retrieving instructional content based on the selected subset of sales behaviors to provide at least a portion of the sales person instructional program, the instructional content including instructional content associated with (i) a knowledge portion of the instructional program, (ii) a pretest portion of the instructional program, (iii) a classroom portion of the instructional program, (iv) a post reinforcement portion of the instructional program, and (v) a post assessment portion of the instructional program including at least one of a level two cognitive ability assessment, a level three behavioral assessment, and a level four correlation assessment.

26. The method of claim 25, including administering a pre-assessment competency test of sales skills to the plurality of sales people to produce a plurality of individual test results, wherein selecting the subset of sales behaviors from the plurality of predetermined sales behaviors is based on the plurality of individual test results.

27. The method of claim 26, wherein administering the pre-assessment competency test of sales skills includes administering an objective pre-assessment competency test of sales skills.

28. The method of claim 25, including analyzing a purchasing process associated with the plurality of sales people to produce a purchasing process analysis result, wherein selecting the subset of sales behaviors from the plurality of predetermined sales behaviors is based on the purchasing process analysis result.

29. The method of claim 25, further comprising performing customer segmentation analysis associated with the plurality of sales people to produce a customer segmentation analysis result, wherein selecting the subset of sales behaviors from the plurality of predetermined sales behaviors is based on the customer segmentation analysis result.

30. The method of claim 29, wherein the customer segmentation analysis result includes a customer size indicator and a product complexity indicator.

31. The method of claim 25, wherein the post reinforcement portion of the instructional program includes at least one of a coaching portion, an individual activities portion, and a group activities portion.

32. The method of claim 25, wherein a first portion of the retrieved instructional content is static content and a second portion of the retrieved instructional content is dynamic content, the method including customizing the dynamic content based on the job task analysis result.

33. The method of claim 25, wherein the post reinforcement portion of the instructional program includes at least one of a coaching portion, an individual activities portion, and a group portion.

34. The method of claim 25, wherein a first portion of the retrieved instructional content is static content and a second portion of the retrieved instructional content is dynamic content, the method including customizing the dynamic content based on the job the job task analysis result.

35. A method of organizing instructional content in a computer readable media, the method comprising:
storing first data indicative of a first mapping of a first selling behavior to first static instructional content;
storing second data indicative of a second mapping of the first selling behavior to first dynamic instructional content;
storing third data indicative of a third mapping of a second selling behavior to second static instructional content, the second selling behavior being different than the first selling behavior, the second static instructional content being different than the first static instructional content; and
storing fourth data indicative of a fourth mapping of the second selling behavior to second dynamic instructional content, the second dynamic instructional content being different than the first dynamic instructional content.

36. The method of claim 35, wherein the first static instructional content is associated with a knowledge step of an instructional process and the first dynamic instructional content is associated with a classroom step of an instructional process.

37. The method of claim 35, wherein the first static instructional content is associated with a pretest step of an instructional process and the first dynamic instructional content is associated with a classroom step of an instructional process.

38. The method of claim 35, wherein the first static instructional content is associated with a post assessment step of an instructional process and the first dynamic instructional content is associated with a classroom step of an instructional process.

39. The method of claim 35, wherein the first static instructional content is associated with a knowledge step of an instructional process and the first dynamic instructional content is associated with a post reinforcement step of an instructional process.

40. The method of claim 33, wherein the first static instructional content is associated with a pretest step of an instructional process and the first dynamic instructional content is associated with a post reinforcement step of an instructional process.

41. The method of claim 33, wherein the first static instructional content is associated with a post assessment step of an instructional process and the first dynamic instructional content is associated with a post reinforcement step of an instructional process.

42. An apparatus to provide an instructional program for a plurality of sales people, the apparatus comprising at least one processor programmed to:
administer a pre-assessment competency test of sales skills to the plurality of sales people to produce a plurality of individual test results;
aggregate the plurality of individual test results into a group test result;
receive data indicative of at least one of (i) a job task analysis result associated with the plurality of sales people, and (ii) a customer segmentation analysis result associated with the plurality of sales people;
select a subset of sales behaviors from a plurality of predetermined sales behaviors based on at least two of (i) the job task analysis result, (ii) the customer segmentation analysis result, and the (iii) group test result; and
retrieve instructional content based on the selected subset of sales behaviors to provide at least a portion of the sales person instructional program.

43. The apparatus of claim 42, wherein the processor is programmed to administer the pre-assessment competency test of sales skills as a subjective pre-assessment competency test of sales skills.

44. The apparatus of claim 42, wherein the processor is programmed to administer the pre-assessment competency test of sales skills as an objective pre-assessment competency test of sales skills.

45. The apparatus of claim 42, wherein the retrieved instructional content is associated with (i) a knowledge portion of the instructional program, (ii) a pretest portion of the instructional program, (iii) a classroom portion of the instructional program, (iv) a post reinforcement portion of the instructional program, and (v) a post assessment portion of the instructional program.

46. The apparatus of claim 42, wherein the post reinforcement portion of the instructional program includes a at least one of a coaching portion, an individual activities portion, and a group activities portion.

47. The apparatus of claim 42, wherein the post assessment portion of the instructional program includes at least one of a level two cognitive ability assessment, a level three behavioral assessment, and a level four correlation assessment.

48. The apparatus of claim 42, wherein a first portion of the retrieved instructional content is static content and a second portion of the content is dynamic content.

49. A data structure stored on a computer readable media, the data structure organizing instructional content, the data structure comprising:
first data indicative of a mapping of a first selling behavior to first static instructional content;
second data indicative of a mapping of the first selling behavior to first dynamic instructional content;
third data indicative of a mapping of a second selling behavior to second static instructional content, the second selling behavior being different than the first selling behavior, the second static instructional content being different than the first static instructional content; and
fourth data indicative of a mapping of the second selling behavior to second dynamic instructional content, the second dynamic instructional content being different than the first dynamic instructional content.

50. The data structure of claim 49, wherein the first static instructional content is associated with a knowledge step of an instructional process and the first dynamic instructional content is associated with a classroom step of an instructional process.

51. The data structure of claim 49, wherein the first static instructional content is associated with a pretest step of an instructional process and the first dynamic instructional content is associated with a classroom step of an instructional process.

52. The data structure of claim 49, wherein the first static instructional content is associated with a post assessment step of an instructional process and the first dynamic instructional content is associated with a classroom step of an instructional process.

53. The data structure of claim 49, wherein the first static instructional content is associated with a knowledge step of an instructional process and the first dynamic instructional content is associated with a post reinforcement step of an instructional process.

54. The data structure of claim 49, wherein the first static instructional content is associated with a pretest step of an instructional process and the first dynamic instructional content is associated with a post reinforcement step of an instructional process.

55. The data structure of claim 49, wherein the first static instructional content is associated with a post assessment step of an instructional process and the first dynamic instructional content is associated with a post reinforcement step of an instructional process.

56. A method of providing an instructional program for a plurality of sales people, the method comprising:
administering a pre-assessment competency test of sales skills to the plurality of sales people to produce a plurality of individual test results, the pre-assessment competency test of sales skills including a subjective portion and an objective portion;
aggregating the plurality of individual test results into a group test result;
performing a job task analysis associated with the plurality of sales people to produce a job task analysis result, wherein performing the job task analysis includes providing at least one question to analyze the mindset of a prototypical buyer;
performing customer segmentation analysis associated with the plurality of sales people to produce a customer segmentation analysis result, wherein the customer segmentation analysis result includes a customer size indicator and a product complexity indicator;
selecting a subset of sales behaviors from a plurality of predetermined sales behaviors based on the job task analysis result, the group test result, and the customer segmentation analysis result;
retrieving instructional content based on the selected subset of sales behaviors to provide at least a portion of the sales person instructional program, wherein a first portion of the retrieved instructional content is static content and a second portion of the content is dynamic content, wherein the retrieved instructional content is associated with (i) a knowledge portion of the instructional program, (ii) a pretest portion of the instructional program, (iii) a classroom portion of the instructional program, (iv) a post reinforcement portion of the instructional program including at least one of a coaching portion, an individual activities portion, and a group activities portion, and (v) a post assessment portion of the instructional program including a level two cognitive ability assessment, a level three behavioral assessment, and a level four correlation assessment; and
customizing the dynamic content based on the job task analysis result and the customer segmentation analysis result.
